(19) United States
(12) Patent Application Publication
(10) Pub. No.: US 2010/0318200 A1
(43) Pub. Date: Dec. 16, 2010

(54) Method and System for Providing an Integrated Building Summary Dashboard

(75) Inventors: Wendy Foslien, Woodbury, MN (US); Steve Gabel, Golden Valley, MN (US); Conrad Bruce Beaulieu, Duluth, MN (US); Greg Bernhardt, Hopkins, MN (US)

Correspondence Address: HONEYWELL/ORTIZ & LOPEZ;PATENT SERVICES, 101 Columbia Road, Morristown, NJ, 07962-2245, US

(73) Assignee: Honeywell International Inc.

(21) Appl. No.: 12/483,433

(22) Filed: Jun. 12, 2009

(51) Int. Cl. G05B 15/02; G06F 3/048; G06F 1/28; G05D 23/00; G06Q 10/00

(52) U.S. Cl. 700/83; 715/772; 715/738; 700/286; 700/276; 705/7; 715/763

(57) ABSTRACT

A method and system for providing an integrated building summary dashboard application. The dashboard can be implemented, for example, as a Rich Internet Application (RIA), which integrates with multiple data sources. A data warehouse can be utilized to consolidate and store the data related to a particular dashboard. The dashboard can be configured by integrating high-level metrics with key performance indicators to provide an overview, which can then be granularized to provide detailed information. The dashboard can also be configured to include a data chart that provides a “glimpse” of information associated with key performance indicators. The data chart can be configured to utilize a target bar as input to an interactive what-if analysis, and an output can be utilized to automatically drive control automation system changes.

### TECHNICAL FIELD

Embodiments are generally related to data-processing systems and methods. Embodiments also relate in general to the field of computers and similar technologies, and in particular to software utilized in this field. In addition, embodiments relate to building summary dashboard applications.

### BACKGROUND OF THE INVENTION

Dashboards can be displayed, which provide to an end-user, a concise presentation of targeted and relevant information related to performance data associated with a business. Dashboards allow users a real-time snapshot of the performance of a business in order to make informed and high quality decisions in a timely fashion.

A building summary dashboard is a collection of data visualization tools that allow users to quickly acquire an overview of the performance of a commercial building, and the reasons behind such a performance. A building's operating performance can be evaluated based on actual energy costs, projected maintenance costs, energy consumption benchmarks and baselines, carbon emissions benchmarks and baselines, alarms generated by an automation system, comfort measures, in-door air quality measures, recommendations for operations improvement and so forth. The purpose of such a building summary dashboard is to provide decision support information to facilities and financial management personnel. Such building summary dashboards may be additionally utilized to analyze large amounts of data and efficiently display and summarize data supplied by a database program. Conventional building control system interfaces offer little interactivity and provide limited data visualization capability.

Based on forgoing it is believed that a need exists for an improved method and system for configuring an integrated building summary dashboard application. A need also exists for configuring a key performance indicator in association with a bullet chart or other visualization in the building summary dashboard, as described in greater detail herein.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the present invention to provide for an improved data-processing method, system and computer-usable medium.

It is another aspect of the present invention to provide for a method, system and computer-usable medium for configuring an integrated building summary dashboard application.

It is a further aspect of the present invention to provide for a method and system for configuring a key performance indicator associated with a data chart (e.g., a bullet chart) in the context of a building summary dashboard.

The aforementioned aspects and other objectives and advantages can now be achieved as described herein. A method and system for configuring an integrated building summary dashboard application in order to provide better access to drive operational decisions is disclosed. The dashboard can be implemented, for example, as a Rich Internet Application (RIA), which can be integrated with multiple data sources. A data warehouse can be utilized to consolidate and store the data (e.g., energy, alarms, HVAC, service) related to a dashboard. The dashboard can be configured to integrate high-level metrics with key performance indicators (KPIs) in order to provide an overview of a building performance. The key performance indicators can then be granularized to provide detailed information. The dashboard can also be configured to include, for example, a bullet chart or other visualization capable of offering a glimpse of the status associated with key performance indicators and performance against goals for those indicators. Such a chart may be configured to further utilize a target bar as input to an interactive “what if” analysis and an output can be utilized to automatically drive control automation system changes.

Such an approach enables data analysis and visualization capabilities to be delivered through a variety of end user devices (e.g., a personal computer, mobile device, handheld device, etc.). The dashboard also provides an immediate actionable representation of building energy data tied to an economic and environmental impact. Cumbersome reports generated and analyzed by HVAC control or other domain experts can then be converted into operational actions capable of being performed manually or automatically. The dashboard displays an immediate economic and carbon impact regarding prospective decisions and thereafter creates a “before and after” visualization of the results over time.

Information such as, ENERGY® ratings and carbon emissions estimates, can be derived from the data included in the data warehouse. Such an approach enables the dynamic addition and deletion of various cross-correlated information views from other domains such as, for example, access control, asset management, life safety, security, intrusion and video surveillance, lighting, accessory equipment, and indoor air quality equipment. Note that ENERGY STAR® is a government-backed program helping businesses and individuals protect the environment through superior energy efficiency.

An operator can create custom high-level views in real-time or over previous periods of time so that correlations can be drawn around performance information related to building operations events. Such a dashboard can be easily associated with other domain information in an integrated visualization context. The dashboard summary can also be viewed via an integrated display of a distributed building management system to enable field use by building technicians and other personnel.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system in which the present invention may be embodied;

FIG. 2 illustrates a schematic view of a software system including an operating system, application software, and a user interface for carrying out the present invention;

FIG. 3 depicts a graphical representation of a network of data processing systems in which aspects of the present invention may be implemented;

FIG. 4 illustrates a block diagram of an integrated building summary dashboard system, in accordance with a preferred embodiment;

FIG. 5 illustrates a graphical user interface of an integrated building summary dashboard, in accordance with an exemplary embodiment;

FIG. 6 illustrates a graphical user interface of an integrated building summary dashboard in association with key performance indicators and a data chart, in accordance with a preferred embodiment; and

FIG. 7 illustrates a detailed flow chart of operations illustrating logical operational steps of a method for configuring the integrated building summary dashboard, in accordance with a preferred embodiment.

### DETAILED DESCRIPTION

The particular values and configurations discussed in these non-limiting examples can be varied and are cited merely to illustrate at least one embodiment and are not intended to limit the scope thereof.

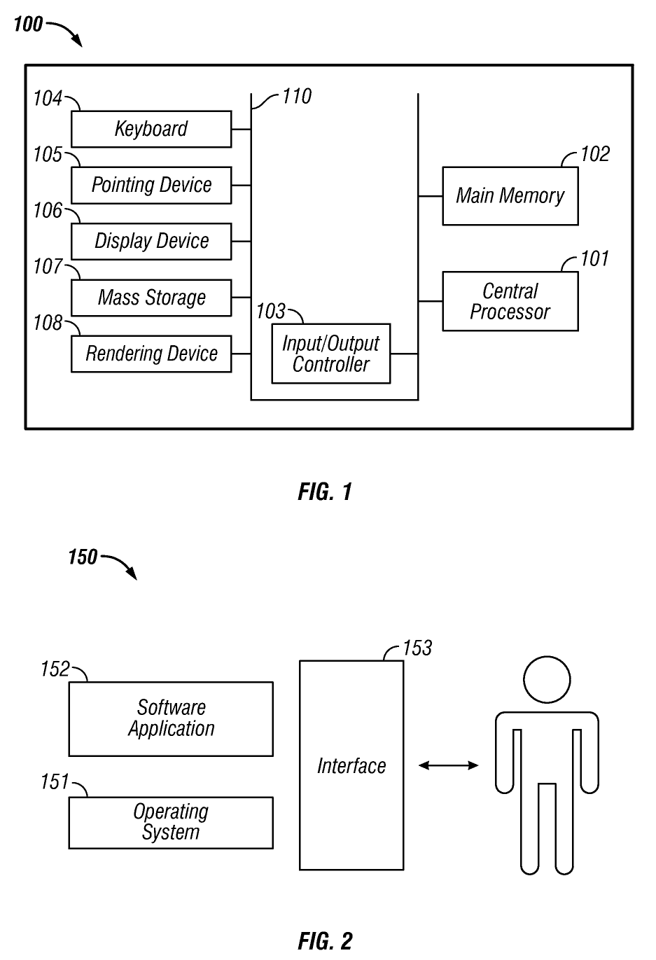

FIGS. 1-3 are provided as exemplary diagrams of data processing environments in which embodiments of the present invention may be implemented. It should be appreciated that FIGS. 1-3 are only exemplary and are not intended to assert or imply any limitation with regard to the environments in which aspects or embodiments of the present invention may be implemented. Many modifications to the depicted environments may be made without departing from the spirit and scope of the present invention.

As depicted in FIG. 1, the present invention may be embodied and/or implemented in the context of a data-processing system 100 that generally includes a central processor 101, a main memory 102, an input/output controller 103, an input device 104 such as, for example, a keyboard 104, a pointing device 105 (e.g., mouse, track ball, pen device, or the like), a display device 106, and a mass storage 107 (e.g., hard disk). Additional input/output devices, such as a rendering device 108, may be utilized association with the data-processing system 100 as desired. As illustrated, the various components of the data-processing system 100 communicate through a system bus 110 or similar architecture.

Illustrated in FIG. 2, a computer software system 150 is provided for directing the operation of the data-processing system 100. Software system 150, which is stored in system memory 102 and on disk memory 107, includes a kernel or operating system 151 and a shell or interface 153. One or more application programs, such as application software 152, may be “loaded” (i.e., transferred from storage 107 into memory 102) for execution by the data-processing system 100. The data-processing system 100 receives user commands and data through user interface 153; these inputs may then be acted upon by the data-processing system 100 in accordance with instructions from operating module 151 and/or application module 152.

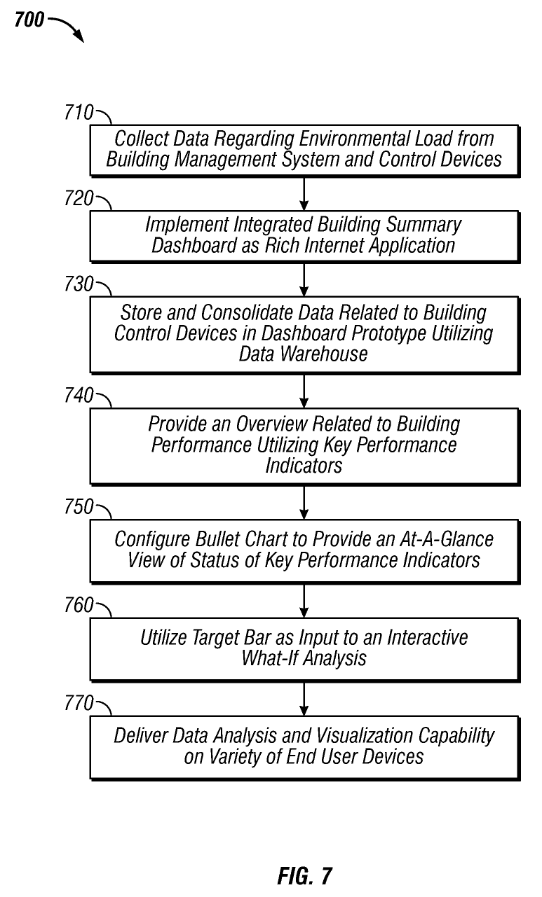

The interface 153, which is preferably a graphical user interface (GUI), also serves to display results, whereupon the user may supply additional inputs or terminate the session. In one particular embodiment, operating system 151 and interface 153 can be implemented in the context of a “Windows” system. In another embodiment, operating system 151 and interface 153 may be implemented in the context of other operating systems, such as Linux, UNIX, etc. Application module 152, on the other hand, can include instructions, such as the various operations described herein with respect to the various components and modules described herein, such as, for example, the method 700 depicted in FIG. 7.

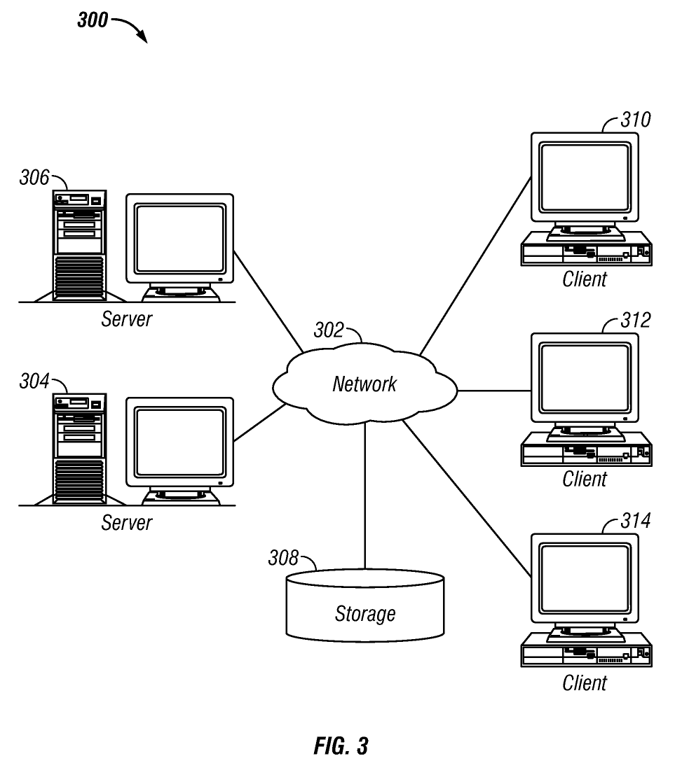

FIG. 3 depicts a graphical representation of a network of a data processing system 300 in which aspects of the present invention may be implemented. Network data processing system 300 contains network 302, which is the medium used to provide communications links between various devices and computers connected together within network data processing system 100. Network 102 may include connections, such as wire, wireless communication links, or fiber optic cables.

In the depicted example, server 304 and server 306 connect to network 302 along with storage unit 308. In addition, clients 310, 312, and 314 connect to network 302. These clients 310, 312, and 314 may be, for example, personal computers or network computers. Data-processing system 100 depicted in FIG. 1 can be, for example, a client such as client 310, 312, and/or 314. Alternatively, data-processing system 100 can be implemented as a server, such as servers 304 and/or 306, depending upon design considerations.

In the depicted example, server 304 provides data, such as boot files, operating system images, and applications to clients 310, 312, and 314. Clients 310, 312, and 314 are clients to server 304 in this example. Network data processing system 300 may include additional servers, clients, and other devices not shown. Specifically, clients may connect to any member of a network of servers, which provide equivalent content.

In the depicted example, network data processing system 300 is the Internet with network 302 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 300 also may be implemented as a number of different types of networks, such as for example, an intranet, a local area network (LAN), or a wide area network (WAN). FIG. 1 is intended as an example, and not as an architectural limitation for different embodiments of the present invention.

The following description is presented with respect to embodiments of the present invention, which can be embodied in the context of a data-processing system such as data-processing system 100 and computer software system 150 depicted respectively in FIGS. 1-2. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments, which follows, is for purposes of illustration and not considered a limitation.

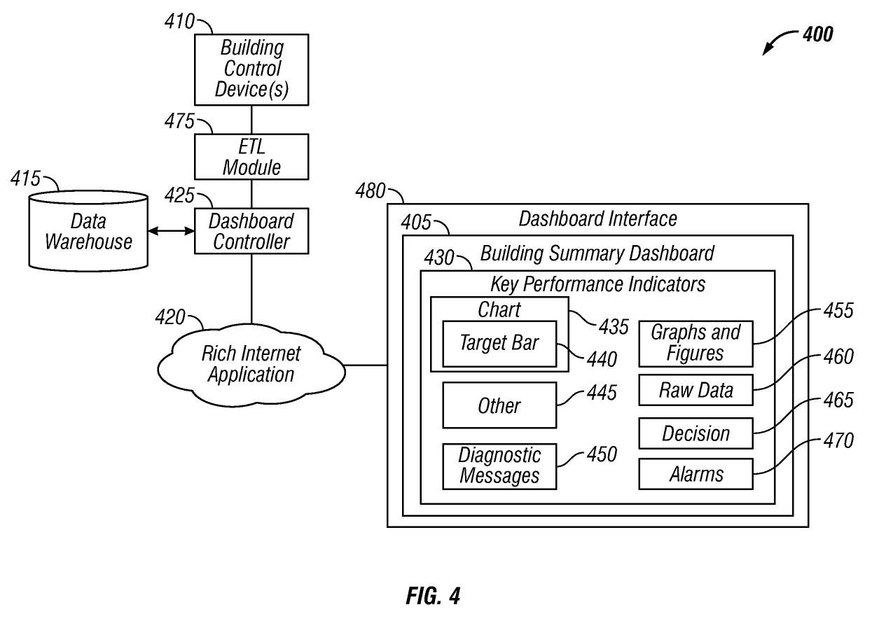

FIG. 4 illustrates a block diagram of an integrated building summary dashboard system 400, in accordance with a preferred embodiment. Note that in FIGS. 1-7, identical or similar blocks are generally indicated by identical reference numerals. The system 400 can be configured to include a dashboard controller 425 in association with a dashboard interface 480 for configuring an integrated building summary dashboard application 405. The building summary dashboard 405 provides an overview of a commercial building operating performance and reasons behind such performance. The building summary dashboard 405 allows presentation of complex relationships and performance metrics in a format that is easily understandable by time-pressured managers. The system 400 collects, processes and displays real time and historical data related to an environmental load (energy emissions, and water) from a variety of building control devices 410 associated with a building. The dashboard controller 425 designs the appearance and functions of the dashboards 405 for the specific needs of a user.

The information from the building control devices 410 can be transferred to an ETL (Extraction, Transformation and Loading) module 475 capable of implementing ETL instructions. Before the data from the building control device(s) 410 enters the data warehouse 415, the system 400 ensures that the data passes a data quality threshold. The ETL process implemented by the ETL module 475 involves extracting data from the building control device(s) 410, transforming such data to fit business needs (which may include quality levels), and ultimately loading the data into the end target, i.e. the data warehouse 415. Dashboard applications can be configured to provide a concise set of high-level graphical views into the data warehouse 415, thereby enabling facility managers to analyze specific aspects of the building energy events. The data warehouse 415 is generally configured as a centralized repository that stores data associated with the building control device(s) 410 and transforms the information into a dashboard controller 425 for efficient querying and analysis. The dashboard controller 425 can be configured as a module that calculates trends and generates alerts for energy and property managers.

The dashboard 405 can be configured to integrate high-level metrics with key performance indicators 430 to provide an overview related to the performance of the building. The data may be further analyzed by selecting data labels within the key performance indicators 430 and perform a ‘drill down’ operations (e.g. a mouse click to bring up a new web page) for more detail information. The dashboard 405 also includes many charts such as, for example, a data chart 435 to provide an at-a-glance view of the status of the key performance indicators 430. The data chart 435 further employs the use of a target bar 440 as input to an interactive “what if” analysis. The output of the analysis can be utilized to automatically drive control automation system changes.

The key performance indicators 430 are simply a metric that is tied to the target bar 440, which often represents how far a metric is above or below the pre-determined target 440. The key performance indicators 430 are shown as a ratio of actual to target and are designed to instantly let a user know if they are on or off the plan without the end user having to consciously focus on the metrics being represented. The dashboard 405 integrates high-level metrics with yearly, monthly and daily key performance indicators 430.

The key performance indicators 430 represent a rapid and efficient approach for the delivery of information, and are an integral part of the dashboard system 400. The graphically displayed data chart 435 can be utilized in association with the dashboard 405 to communicate key performance indicators 430 and other related date. In addition to providing quick analysis tools such as key performance indicators 430, the dashboard summary system 400 permits a user to analyze the root causes of performance from many different perspectives. The dashboard summary system 400, for example, allows a user to quickly monitor and analyze the performance of a building. The dashboard 405 can also be configured to include graphs and other FIGS. 455, diagnostic messages 450, raw data 460, alarms 470, decisions 465 and other information 445 based on real time and historical data from the building control device(s) 410 and the data warehouse 415.

The dashboard 405 can be implemented, for example, as a Rich Internet Application (RIA) 420, which integrates with multiple data sources. The data warehouse 415 can be utilized to store the data and the RIA 420 for delivery. Note that the acronym RIA is a generic term for a web application that exhibits a user interface behavior similar to normal desktop applications, with user interactivity and responsiveness. The RIA 420 supports background data refreshes to ensure that the dashboard(s) 405 are kept up-to-date, and possesses improved visualization and interactivity features over traditional web applications.

The RIA 420 can push data from the server to the client to provide updated information, notifications and alerts. The RIA 420 offers integral support for retrieving data from multiple sources and provides improved visualization of information. The system 400 enables a data analysis and visualization capability to be delivered on a variety of dashboard user interface 480 such as, for example, a personal computer, a mobile device and/or a handheld device. The dashboard user interface 480 may be, for example, graphically displayed on the display device of data-processing system 100 and/or provided by the interface 152 depicted in FIG. 2. The building summary dashboard 405 can be viewed on an integrated display of a distributed building management system controller, and to enable field use by a building technician.

The dashboard interface 480 provides an immediate actionable representation of a building energy data tied to economic and environmental impact. The system 400 also generates cumbersome reports that can be analyzed by a HVAC (Heating Ventilation Air Conditioning) control or other domain experts and can then be turned into economic actions that are performed manually or automatically. The dashboard 405 displays an immediate economic and carbon impact of prospective decisions and then creates a before and after visualization of the results over time. The data warehouse 415 can be utilized to consolidate much of the data associated with a dashboard prototype (energy, alarms, HVAC, service). The information, such as ENERGY STAR ratings and carbon emissions estimates can be derived from the data included in the data warehouse 415.

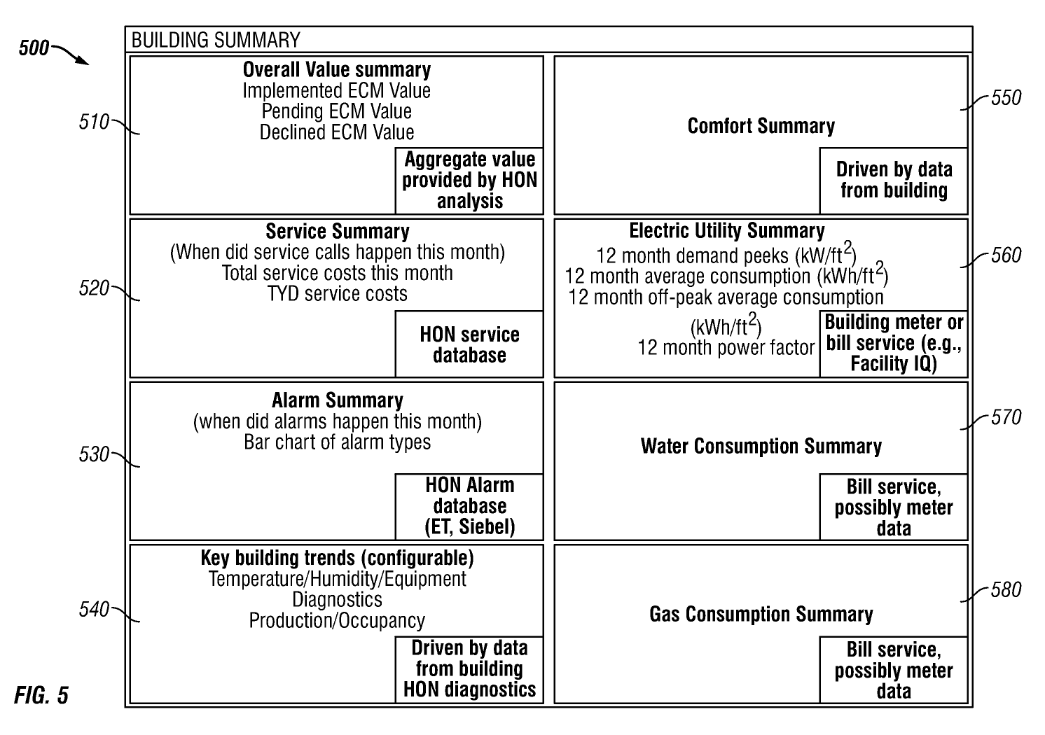

FIG. 5 illustrates an integrated building summary dashboard 500, in accordance with an exemplary embodiment. The building summary dashboard 500 can be implemented in the context of a GUI that includes a number of graphical display areas for the display of data. For example, dashboard 500 display one or more data analysis reports such as an overall value summary 510, a comfort summary 550, a service summary 520, an electric utility summary 560, an alarm summary 530, a water consumption summary 570, key building trends 540 and gas consumption summary 580.

The overall value summary 510, for example, displays an overview of the operating performance of the building control devices 410. The comfort summary 550 can display a summary of various comfort factors such as, for example, HVAC parameters associated with the building control devices 410. The service summary 520 also can generate a detailed summary of the service calls and a service cost related to the building control devices 410 for certain periods. The electric utility summary 560 displays details related to, for example, demand peaks, average consumption and power factor of electricity of the building. The alarm summary 530 illustrates instances of alarms during certain periods. The water consumption summary 570 and gas consumption summary 580 displays an overview of the consumption of water and gas in the building, respectively. The key building trends 540 displays trend data related to temperature, humidity, equipment and occupancy of the building.

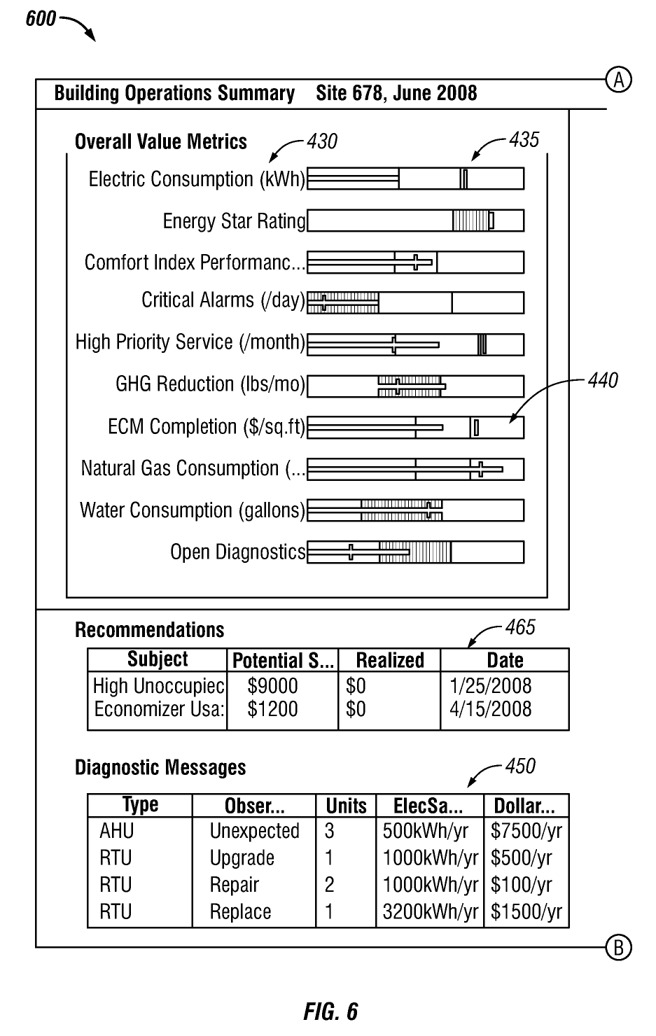

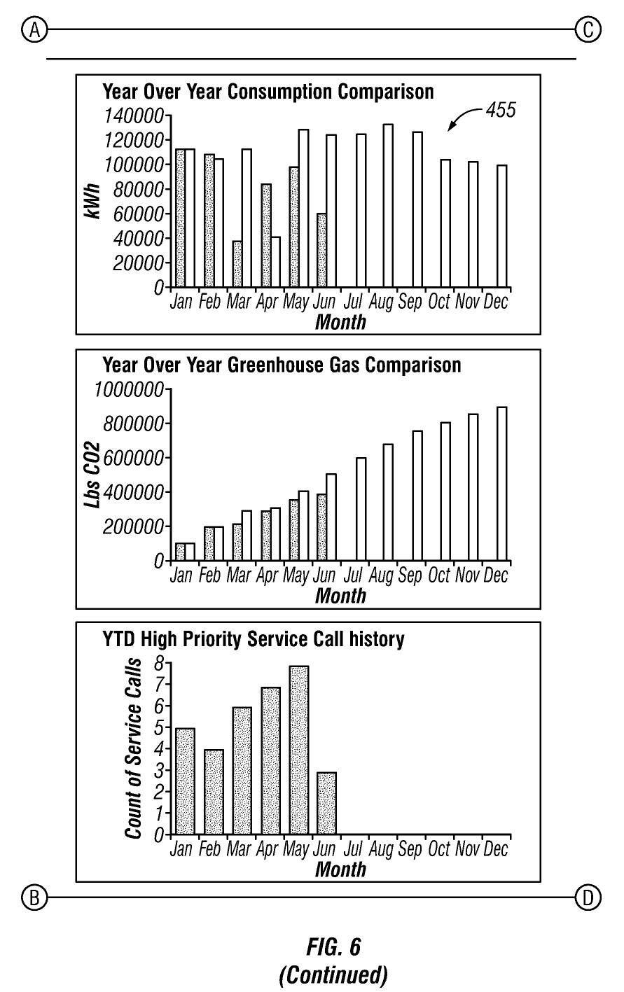

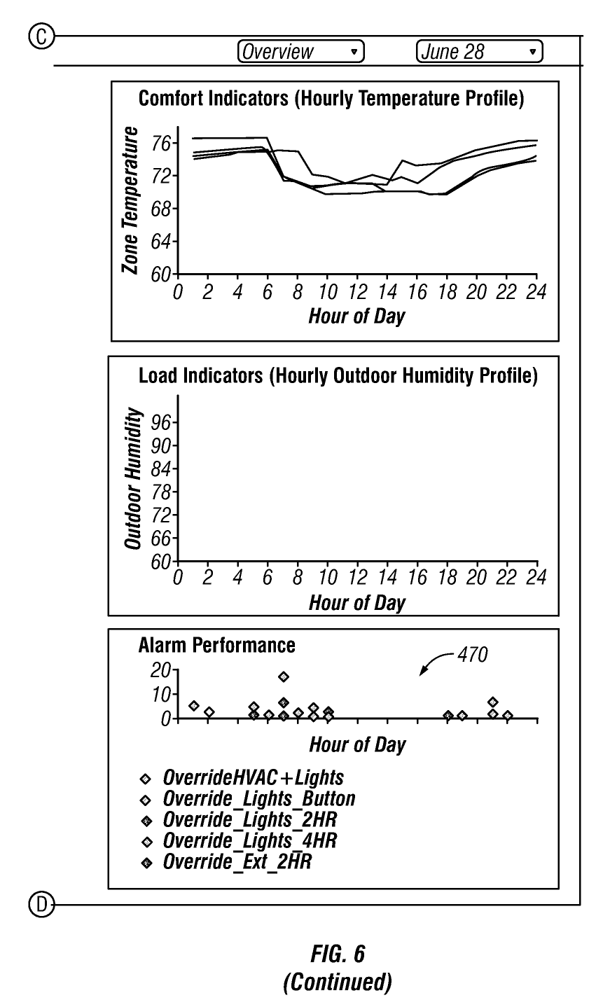

FIG. 6 illustrates a dashboard 600 in association with key performance indicators 430 and the data chart 435, in accordance with a preferred embodiment. Dashboard 600 can also be implemented in the context of a GUI. Again, as a reminder, in FIGS. 1-7, identical or similar blocks are generally indicated by identical reference numerals. The building summary dashboard 600 displays a consistent set of graphically standard controls, including dropdown boxes, buttons, and radio buttons, as illustrated in FIG. 6. The data chart 435, for example, can display the status of key performance indicators 430 for the building. Dashboard 600 can display the overall value metrics with yearly, monthly and daily key performance indicators 430. The key performance indicators 430 provide an overview of electric consumption, comfort index performance, alarms, carbon emissions reduction, energy conservation measurement data, natural gas and water consumption, building HVAC diagnostics, and so forth.

The key performance indicators 430 can then be drilled down into for detail information. The graphical user interface 600 can also includes one or more graphically displayed charts 435 capable of providing an at-a-glance view of the status of the key performance indicators 430. In some embodiments, such a graphically displayed data chart 435 may be displayed in the format of, for example, a bullet chart or another visualization medium. In other embodiments, chart 436 may be graphically displayed as a table, tabulation, graph or any other appropriate graphical medium that provides detailed information. The data chart 435 may be modeled on a format similar to, for example, an audio level meter. The data chart 435 can be configured to include a vertical bar that can slide along a horizontal axis showing a current value by the location according to the scale on the horizontal axis. In other embodiments, the bar may change color based on the value of the KPI target range (e.g., red for poor, yellow/orange for okay and blue for good). Of course, it can be appreciated that such a change of color approach may not be utilized with other embodiments and is not considered a limiting feature of the present invention. Other non-color based approaches can be utilized in lieu of color.

The graphically displayed data chart 435 utilizes a graphical target bar 440 as input to an interactive “what if” model. For example, if the energy consumption target is reduced by 5%, the resulting savings can be determined utilizing the chart 435 and the target bar 440. The target ranges can be shaded in the background of the chart 435, with the target value shown by a dark blue target circle. The output from the “what if” analysis can be utilized to automatically drive control automation system changes.

FIG. 7 illustrates a detailed flow chart of operations illustrating logical operational steps of a method 700 for configuring the integrated building summary dashboard 405, in accordance with a preferred embodiment. Note that the method 700 can be implemented in the context of a computer-useable medium that contains a program product. The method 700 depicted in FIG. 7 can also be implemented in a computer-usable medium containing a program product.

The data regarding environmental loads and related operational parameters can be collected from building control devices 410 related to the building, as depicted at block 710. The integrated building summary dashboard 405 can be configured as RIA 420, as illustrated at block 720. The data related to building control devices 410 in the dashboard prototype can be stored and consolidated utilizing data warehouse 415, as indicated at block 730. Thereafter, as illustrated at block 740, an overview related to the building performance can be provided utilizing key performance indicators 430. The chart 435 can be configured to provide an at-a-glance view of status of the key performance indicators 430, as depicted at block 750. The target bar 440 in association with the chart 435 can be utilized as input to an interactive “what if” model, as indicated at block 760. The data analysis and visualization capability can be delivered on a variety of end user devices 480, as depicted at block 770.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

The integrated building summary dashboard system 400 provides a flexible means to visualize a total environmental operational load with special focus on energy consumption, energy savings, and energy generation for people, assets, buildings, and complete property portfolios. The actual cost of energy, energy consumption and carbon emissions, occupants can be measured and presented for more aware of energy usage and thereby introducing energy efficient solutions.

Such an approach enables a dynamic addition and deletion of various cross-correlated information views from other domains such as access control, asset management, life safety, security, intrusion and video surveillance, lighting, accessory equipment, indoor air quality equipment. An operator can create custom high-level views in real-time or over previous periods of time so that correlations can be drawn around what happened during building energy events. The dashboard 405 enables an easy integration of other domain information in an integrated visualization.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for monitoring a building, said method comprising:
compiling performance summary data associated with a building by integrating high-level metrics with at least one key performance indicator that is granularized to provide detailed performance information associated with said building; and
configuring a dashboard to graphically display said performance summary data including said at least one performance indicator to thereby generate information for driving operational decisions with respect to said building.

2. The method of claim 1 further comprising:
assembling a data chart that provides information indicative of said at least one key performance indicator; and
displaying said data chart via said dashboard.

3. The method of claim 1 further comprising associating said dashboard with at least one building control device for controlling said building.

4. The method of claim 1 further comprising configuring a data warehouse to store and consolidate data related to said dashboard.

5. The method of claim 1 further comprising configuring said dashboard to deliver data analysis and visualization to a plurality of end user devices.

6. The method of claim 1 further comprising displaying said dashboard on an integrated display associated with a distributed building management system controller for use by a building technician.

7. The method of claim 1 further comprising configuring said dashboard to display an immediate actionable graphical representation of building energy data associated with said building, wherein said building energy data is tied to economic and environmental impact factors.

8. The method of claim 1 further comprising configuring said dashboard to generate at least one report capable of being analyzed by an HVAC control component and thereafter converted into an economic action.

9. The method of claim 1 further comprising:
configuring said dashboard to display information indicative of an immediate economic and a carbon impact of prospective decisions; and
thereafter creating a before and after visualization of results over time.

10. The method of claim 1 further comprising configuring said dashboard to dynamically add and delete cross-correlated information from at least one domain, in order to subsequently create a custom high-level view in real-time and/or over previous periods of time of information related to said building.

11. A system for monitoring a building, said system comprising:
a processor;
a data bus coupled to said processor; and
a computer-usable medium embodying computer code, said computer-usable medium being coupled to said data bus, said computer program code comprising instructions executable by said processor and configured for:
compiling performance summary data associated with a building by integrating high-level metrics with at least one key performance indicator that is granularized to provide detailed performance information associated with said building; and
configuring a dashboard to graphically display said performance summary data including said at least one performance indicator to thereby generate information for driving operational decisions with respect to said building.

12. The system of claim 11 wherein said instructions are further configured for:
assembling a data chart that provides information indicative of said at least one key performance indicator; and
displaying said data chart via said dashboard.

13. The system of claim 11 wherein said dashboard is associated with at least one building control device for controlling said building.

14. The system of claim 11 wherein said instructions are further configured for
establishing a data warehouse to store and consolidate data related to said dashboard;
permitting said dashboard to deliver data analysis and visualization to a plurality of end user devices; and
displaying said dashboard on an integrated display associated with a distributed building management system controller for use by a building technician.

15. A system for monitoring a building, said system comprising:
a processor;
a data bus coupled to said processor; and
a computer-usable medium embodying computer code, said computer-usable medium being coupled to said data bus, said computer program code comprising instructions executable by said processor and configured for:
compiling performance summary data associated with a building by integrating high-level metrics with at least one key performance indicator that is granularized to provide detailed performance information associated with said building; and
configuring a dashboard to graphically display said performance summary data including said at least one performance indicator to thereby generate information for driving operational decisions with respect to said building;
assembling a data chart that provides information indicative of said at least one key performance indicator; and
displaying said data chart via said dashboard.

16. The system of claim 15 wherein said instructions are further configured for configuring said dashboard to display an immediate actionable graphical representation of building energy data associated with said building, wherein said building energy data is tied to economic and environmental impact factors.

17. The system of claim 15 wherein said instructions are further configured for configuring said dashboard to generate at least one report capable of being analyzed by an HVAC control component and thereafter converted into an economic action.

18. The system of claim 15 wherein said instructions are further configured for:
configuring said dashboard to display information indicative of an immediate economic and a carbon impact of prospective decisions; and
thereafter creating a before and after visualization of results over time.

19. The system of claim 15 wherein said instructions are further configured for modifying said dashboard to dynamically add and delete cross-correlated information from at least one domain, in order to subsequently create a custom high-level view in real-time and/or over previous periods of time of information related to said building.

20. The system of claim 15 wherein said dashboard is associated with at least one building control device for controlling said building.
